(19) United States
(12) Patent Application Publication
(10) Pub. No.: US 2015/0301621 A1
(43) Pub. Date: Oct. 22, 2015

(54) METHOD FOR CONTROLLING CURSOR SPEED

(71) Applicants: Johnny Chen, Taipei City (TW); Hung-Jen Wu, Taipei City (TW); Kun-Yuan Lin, Taipei City (TW)

(72) Inventors: Johnny Chen, Taipei City (TW); Hung-Jen Wu, Taipei City (TW); Kun-Yuan Lin, Taipei City (TW)

(73) Assignee: I/O INTERCONNECT INC., Taipei City (TW)

(21) Appl. No.: 14/445,044

(22) Filed: Jul. 28, 2014

Related U.S. Application Data
(60) Provisional application No. 61/981,850, filed on Apr. 21, 2014.

(51) Int. Cl. G06F 3/038; G06F 17/30; G06F 3/0354

(52) U.S. Cl. CPC G06F 3/038; G06F 3/03543; G06F 17/30876

(57) ABSTRACT

The method includes the steps of: a) creating a mouse database in a docking station; b) wiredly connecting a mouse to the docking station; c) connecting the docking station to a handheld computer; d) showing a cursor on the handheld computer; e) the docking station obtaining a model name of the mouse; f) automatically selecting a parameter from the mouse database according to the model name; g) determining a numeral value by a formula with the parameter; and h) moving the cursor according to the numeral value.

### CROSS-REFERENCE TO RELATED APPLICATIONS

This application claims priority to provisional applications U.S. 61/981,850, entitled “Method For Controlling Cursor Movement,” filed Apr. 21, 2014.

### BACKGROUND OF THE INVENTION

1. Technical Field

The invention relates to movement of cursor, particularly to adjustment of cursor speed shown on a screen of handheld computer.

2. Related Art

Some users may use a docking station to connect a handheld computer, such as a smartphone or tablet computer, with an input device, such as a mouse or keyboard. Usually, a wireless connection, such as BLUETOOTH, is utilized between the docking station and the handheld computer. The input device is linked to the docking station through a wired connection, such as USB. This arrangement allows users to operate the handheld computer through the external input device.

When a mouse serves as an input device, however, the speed of cursor movement will be a real problem. Because the speed of cursor movement depends on resolutions of the mouse and display of the handheld computer, the speed of cursor movement must be adjusted according to every combination of the mouse and handheld computer. The cursor will move too fast or slowly if the cursor speed is not adjusted to a proper status. This will cause inconvenience to users. However, there is no solution in the market.

### SUMMARY OF THE INVENTION

An object of the invention is to provide a method for controlling cursor speed when using a mouse to move a cursor on a handheld computer through a docking station, which can allow users to automatically control cursor movement speed.

To accomplish the above object, the method of the invention includes the steps of: a) creating a mouse database in a docking station; b) wiredly connecting a mouse to the docking station; c) connecting the docking station to a handheld computer; d) showing a cursor on the handheld computer; e) the docking station obtaining a model name of the mouse; f) automatically selecting a parameter from the mouse database according to the model name; g) determining a numeral value by a formula with the parameter; and h) moving the cursor according to the numeral value.

### BRIEF DESCRIPTION OF THE DRAWINGS

FIG. 1 is a schematic view of hardware arrangement of a handheld computer, a docking station and a mouse of the invention; and

FIG. 2 is a flowchart of the method of the invention.

### DETAILED DESCRIPTION OF THE INVENTION

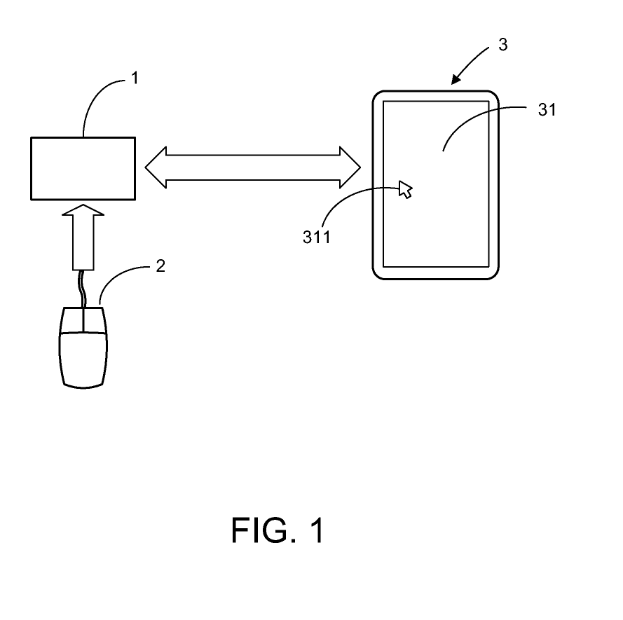

Please refer to FIG. 1. A docking station 1 is connected to a handheld computer 3 such as a smartphone or tablet computer. The connection between the docking station 1 and the handheld computer 3 can be wireless or wired. The wired connection may be the USB (Universal Serial Bus) standard. The wireless connection between the docking station 1 and the handheld computer 3 may be the BLUETOOTH standard. Two BLUETOOTH profiles are used in the wireless connection, namely, the BLUETOOTH-HID (Human Interface Device Profile) and the BLUETOOTH-SPP (Serial Port Profile). An input device, such as a mouse 2 is linked to the docking station 1 through a wired connection, such as the USB (Universal Serial Bus) standard. After the wired and wireless connections have been completed, a cursor 311 will be shown on a display 31 of the handheld computer 3, and the cursor 311 will be moved by the mouse 2 by means of the BLUETOOTH-HID profile.

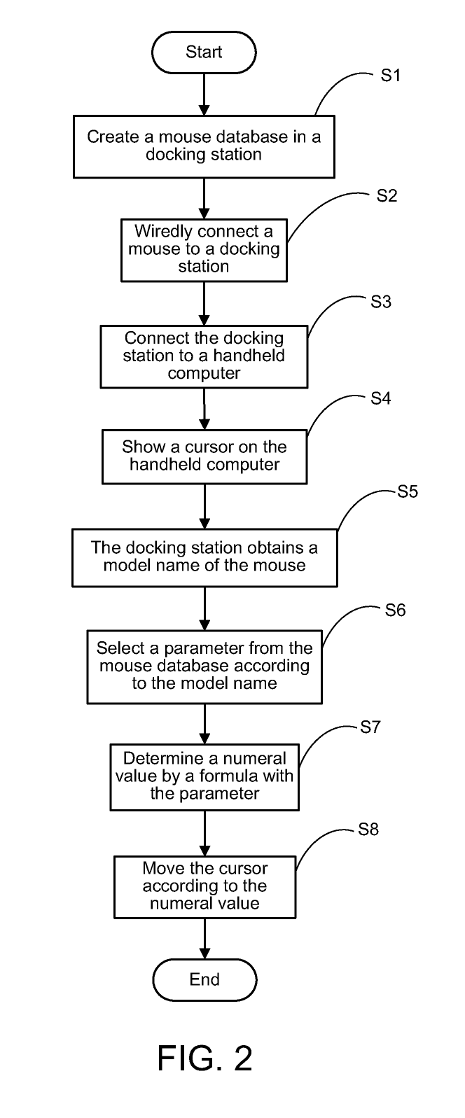

FIG. 2 shows a flowchart of the invention. In step S1, a docking station 1 is provided and a mouse database is crested in the docking station 1. The mouse database is stored in a memory of the docking station. The mouse database possesses information of resolutions of many mice commercially available in the market. In step S2, the mouse 2 is wiredly connected to the docking station 1. In step S3, the handheld computer 3 is connected to the docking station 1. As abovementioned, such a connection can be wired or wireless. In step S4, a cursor 311 is operably shown on the handheld computer 3. As a result, the cursor 311 can be moved by the mouse 2. In step S5, the docking station 1 asks the mouse 2 to obtain a model name of the mouse 2 through the USB path. In step S6, the docking station 1 automatically selects a parameter from the mouse database according to the model name. The steps S5 and S6 are automatically performed by the docking station 1 without a user's operation. As an example, the parameter may be an integer R between 0 and 10000. In step S7, a numeral value is determined by a formula with the parameter. For example, the formula may be (x·R/100) and (y·R/100), where x and y stand for X-ordinate and Y-ordinate, respectively. After the step S7, the cursor 311 is moved according to the value in step S8. The numeral value is a coefficient of motion of the cursor 311 so as to accelerate or decelerate the motion of the cursor 311.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for controlling cursor speed, comprising the steps of:
a) creating a mouse database in a docking station;
b) wiredly connecting a mouse to the docking station;
c) connecting the docking station to a handheld computer;
d) showing a cursor on the handheld computer;
e) the docking station obtaining a model name of the mouse;
f) automatically selecting a parameter from the mouse database according to the model name;
g) determining a numeral value by a formula with the parameter; and
h) moving the cursor according to the numeral value.

2. The method of claim 1, wherein the step b) is implemented by a USB (Universal Serial Bus) standard.

3. The method of claim 1, wherein the step c) is wired performed to form a wireless connection.

4. The method of claim 3, wherein the step c) is wired connection is implemented by a USB standard.

5. The method of claim 1, wherein the step c) is wirelessly performed to form a wired connection.

6. The method of claim 5, wherein the wireless connection is implemented by a BLUETOOTH standard.

7. The method of claim 6, wherein the BLUETOOTH standard further comprises a BLUETOOTH-HID (Human Interface Device) profile and a BLUETOOTH-SPP (Serial Port Profile) profile.
